(19) United States
(12) Patent Application Publication
(10) Pub. No.: US 2011/0130946 A1
(43) Pub. Date: Jun. 2, 2011

(54) METHOD FOR HEATING A GLOW PLUG

(76) Inventors: Markus KERNWEIN, Bretten-Buechig (DE); Joerg Stoeckle, Ludwigsburg (DE)

(21) Appl. No.: 12/941,906

(22) Filed: Nov. 8, 2010

(30) Foreign Application Priority Data
Nov. 28, 2009 (DE) 10 2009 056 261.3

(51) Int. Cl. F02P 19/02

(52) U.S. Cl. 701/113

(57) ABSTRACT

The invention relates to a method for heating a glow plug to a setpoint temperature using a glow program which specifies the course over time of an effective voltage which is generated using pulse width modulation and is applied to heat the glow plug, wherein the glow program is stored in a control device and is provided for the glow plug and other glow plugs of the same model series, the parameters of which match within the scope of manufacturing tolerances. According to the invention, a deviation of a value of a parameter of the glow plug from a nominal value that is typical for a model series is determined, and the glow program is adapted as a function of the deviation. The invention furthermore relates to a glow plug control device for implementing a method of that type.

The invention relates to a method for heating a glow plug to a setpoint temperature using a glow program which specifies the course over time of an effective voltage which is generated using pulse width modulation and is applied to heat the glow plug. A glow program usually specifies the value of an effective voltage that is to be applied to the glow plug at any given time; i.e. how much voltage is to be applied for how long.

Modern glow plug control devices are equipped with a library of various glow programs, each of which is optimized for a certain type of glow plug i.e. a certain model series. In this manner, a glow plug control device can be advantageously used for glow plugs of different model series and still realize a glow operation that is tailored to the glow requirement of the engine and the capacity of the particular glow plug. By controlling the glow plug in an efficient manner, the combustion behavior of an engine can be optimized and the service life of a glow plug can be extended.

### SUMMARY OF THE INVENTION

The object of the present invention is to demonstrate a way in which glow plugs can be controlled even more efficiently.

A method in accordance with the present invention for heating a glow plug to a setpoint temperature using a glow program which specifies the course over time of an effective voltage which is generated using pulse width modulation and is applied to heat the glow plug, includes storing the glow program in a control device, providing for the glow plug and other glow plugs of the same model series, parameters of which match within the scope of manufacturing tolerances, determining a deviation of a parameter of the glow plug from a nominal value that is typical for the model series, and adapting the glow program as a function of the deviation.

### DETAILED DESCRIPTION

The properties of glow plugs within a model series deviate from one another within the scope of manufacturing tolerances. The glow programs stored in conventional control devices therefore account for glow plugs in the upper tolerance range and in the lower tolerance range. In the case of conventional controls, this variance of properties within the scope of manufacturing tolerances makes it impossible to adapt the glow plug operation in an optimal manner to the demands of the engine or the capacity of the glow plugs. Since the position of a given glow plug within the manufacturing-related tolerance range is determined and is accounted for in the control, the heating of a glow plug can be optimized. This applies in particular for ceramic glow plugs, in the case of which it is very difficult to remain within narrow manufacturing tolerances. According to the invention, a deviation of a value of a parameter of a glow plug from a nominal value that is typical for a model series is determined, and the glow program is adapted as a function of the deviation.

Advantageously, a method according to the invention therefore makes it possible to heat a glow plug to a desired target temperature with greater accuracy. It is therefore possible to reduce the influence of manufacturing-related tolerances on the plug temperature, such as the variance of the cold resistance. By using a method according to the invention, it is therefore possible to better adapt the operation of a glow plug to the demands of an engine. This has an advantageous effect on the cold-running behavior and emission behavior of the engine.

The parameter, the deviation of which from a nominal value typical for the model series is determined, is preferably an electrical parameter. Electrical resistance, capacitance, or inductance are suitable parameters, for instance. The parameter that is used does not necessarily have to be an electrical variable, however. For example, the heat capacity of the glow tip can also be used as the parameter.

The electrical parameter, the deviation of which from a nominal value typical for the model series is determined, can be e.g. the electrical resistance of the glow plug at a specified reference temperature. Before the heating of a glow plug is started, it can be generally assumed that the temperature of a glow plug is the same as the temperature of the coolant. Temperature sensors used to measure coolant temperature are usually available anyway in motor vehicles, and therefore the coolant temperature can be provided to a glow plug control device without any additional effort. Advantageously, the coolant temperature can therefore be used as the reference temperature before a glow plug is heated, and the electrical resistance of the cold glow plug can be compared to the nominal value of the electrical resistance of a glow plug of this model series at the particular temperature.

A change in resistance that occurs when the glow plug heats up can also be used, for example, as the electrical parameter, the deviation of which from a nominal value typical for the model series is determined. The change in resistance that occurs during a current pulse of a specified duration is preferably used for this purpose. For example, a resistance measurement can be carried out at the beginning and at the end of a current pulse. Regardless of which electrical parameter is used for the method according to the invention, to determine its value it is generally advantageous to perform a measurement at least at the beginning of a pulse. If necessary, this measurement can be supplemented with a measurement carried out at the end of the pulse.

The deviation of the value of the electrical variable from the nominal value can be used, as an absolute deviation or a relative deviation, as the basis for adapting the glow program. Preferably, the deviation of the parameter from the nominal value is determined as the relative deviation, and, in the glow program, the particular value of the effective voltage is changed in proportion to the relative deviation. If it is determined e.g. that the electrical cold resistance of the glow plug is one percent greater than the nominal value, then the value of the effective voltage can be increased by one percent in the glow program. Although the output that is decisive for the heating of the glow plug is quadratically dependent on the voltage, it is usually sufficient to change the effective voltage proportionally to the relative deviation since the relative deviations are relatively small.

The value of the electrical parameter of the glow plug can be measured by the manufacturer and stored in a data storage device provided with the glow plug. For example, the value of the electrical parameter can be provided in a label on the glow plug, or in a package insert, and can be entered manually in the glow plug control device when the glow plug is installed. It is also possible to store the electrical parameter in a memory device that is attached to the glow plug and can be read out by the glow plug control device.

Regardless of whether the electrical parameter is determined by the glow plug control device by performing a measurement, or is provided by the manufacturer, it is preferable to store the electrical parameter in the glow plug control device and use it for a plurality of heating procedures. This is preferable since, if the parameter is measured anew for each heating procedure, an erroneous value of the electrical parameter may be determined due to an unusual operating state of the vehicle e.g. in which the engine had been operated shortly prior thereto. Given that the electrical parameter in the memory of the glow plug control device is changed only when a plurality of measurements delivers matching results one after the other, the risk of erroneously adapting the glow program can be reduced.

A glow plug control device for implementing a method according to the invention comprises a switch for generating an effective voltage for application to a glow plug via pulse width modulation of a vehicle electrical supply voltage, and a memory in which software comprising glow programs for different model series of glow plugs are stored, a control unit that actuates the switch, during operation, according to one of the stored glow programs, and a sensor for measuring a parameter of a glow plug.

Typically, at least one switch is provided for each glow plug to be controlled, e.g. a power semiconductor. In terms of the hardware components thereof, the glow plug control device substantially corresponds to commercial glow plug control devices, thereby rendering a description thereof unnecessary. The glow plug control device is designed to determine, during operation, a manufacturing-related deviation of a value of a parameter of the glow plug from a nominal value that is typical for the model series, and to adapt the glow program provided for glow plugs in that model series as a function of the deviation.

What is claimed is:

1. A method for heating a glow plug to a setpoint temperature using a glow program which specifies the course over time of an effective voltage which is generated using pulse width modulation and is applied to heat the glow plug, the method comprising:
storing the glow program in a control device;
providing for the glow plug and other glow plugs of a same model series, parameters that match within a scope of manufacturing tolerances,
determining a deviation of a glow plug parameter from a nominal value that is typical for the model series is determined, and
adapting the glow program as a function of the deviation.

2. The method according to claim 1, wherein the parameter is an electrical parameter.

3. The method according to claim 2, wherein the electrical parameter is the electrical resistance of the glow plug at a specified reference temperature.

4. The method according to claim 2, wherein the parameter is a change in resistance that occurs when the glow plug heats up.

5. The method according to claim 4, wherein the electrical parameter is a change in resistance during a current pulse having a specified duration.

6. The method according to claim 1, wherein the glow program is adapted as a function of the deviation by changing the value of the effective voltage in proportion to the relative deviation.

7. The method according to claim 1, wherein the value of the parameter of the glow plug was measured by the manufacturer and stored in a data storage device.

8. The method according to claim 1, wherein the value of the parameter of the glow plug is determined using one or more current pulses at the beginning of a heating procedure.

9. The method according to claim 1, wherein a measurement is carried out at the beginning of a pulse to determine the value of the parameter.
